(19) United States
(12) Patent Application Publication
(10) Pub. No.: US 2007/0078664 A1
(43) Pub. Date: Apr. 5, 2007

(54) Method and instrument for expressing gratitude for a scholastic experience

(76) Inventor: Ryan Thomas Grace, Omaha, NE (US)

Correspondence Address: RYAN T. GRACE;MERCHANT & GOULD, 701 FIFTH AVENUE SUITE 4700, SEATTLE, WA, 98104, US

(21) Appl. No.: 10/440,895

(22) Filed: May 19, 2003

(51) Int. Cl. G06Q 99/00

(52) U.S. Cl. 705/1

(57) ABSTRACT

The purpose of this invention is to provide an improved method of expressing gratitude for a scholastic experience. The method includes a beneficiary and at least one benefactor. The method of expressing gratitude generally comprises the steps of drafting a government document having an expression of gratitude incorporated therein; showing the government document to the benefactor; and interpreting the government document. The government document may be a patent application. The patent application may claim the method by which the beneficiary will express gratitude to the at least one benefactor. The beneficiary could then use the method claimed in the patent application to express gratitude to the at least one benefactor. The patent application could be the expression of gratitude.

### BACKGROUND OF THE INVENTION

1. Field of the Invention

The present invention relates to a method and instrument for expressing gratitude for a scholastic experience. More particularly, the present invention relates to a unique method and instrument for expressing gratitude for a scholastic experience by which a benefactor can appreciate the uniqueness of the expression.

2. Description of the Related Art

Since the advent of the human race, gratitude between individuals has been expressed through various means. In the situation where a child expresses gratitude to a parent, such gratitude is expressed through different avenues as the child ages. At an early age, a child might merely tell a parent “thank you” for a minor favor such as giving the child a cookie. However, as the child ages, the level of effort in expressing gratitude sometimes increases in order to better reflect the level of gratitude the child has for the parents. In many situations, the child may need to implement non-traditional methods of expressing gratitude in order to properly express that the child is truly grateful for everything the parents have done over the child's life.

One method of expressing gratitude to a parent benefactor can be referred to as the “thank you” method. To instigate this method, a child beneficiary will receive some benefit from a parent benefactor. The beneficiary will then express gratitude to the benefactor by verbally telling the benefactor “thank you.” This method of expressing gratitude has several drawbacks. For one, the benefactor may easily forget this method. Also, the beneficiary does not need to contribute much effort in practicing this method. Such a lack of effort may reflect poorly on the level of gratitude that the beneficiary has for the benefactor. Moreover, unless the expression is audio recorded, the benefactor does not have a record of the expression of gratitude.

Another method of expressing gratitude to a benefactor can be referred to as the “card method”. In implementing the card method, a beneficiary usually receives some benefit from a benefactor. The beneficiary then expresses gratitude for the benefit by writing an expression of gratitude in a card and sending the card to the benefactor. In many situations, the benefactor will merely read the card and then toss the card in the garbage. In other situations, the benefactor might position the card on a refrigerator. However, the card usually either ends up in the trash or in a keepsake box. Ultimately, the benefactor will usually forget about such an expression.

Still another method of expressing gratitude to a benefactor might be referred to as the “silver spoon” method. Beneficiaries who have a plethora of money are most likely to practice this method. A benefactor giving a beneficiary some type of benefit usually instigates this method. The beneficiary will then use a portion of the plethora of money to buy something extravagant for the benefactor in order to express gratitude. Such a gift might include a new car, a tropical vacation or a villa in Italy. This method might seem extremely desirable; however, this method has several drawbacks. This method is inaccessible to many members of society inasmuch as they might not have enough money to instigate this method. Furthermore, there are some things that money simply cannot buy no matter how wealthy, famous or politically powerful a beneficiary might be.

As the Industrial Revolution has passed and the computer revolution has taken afoot, society has been submerged with innovation and novel ideas. With the regularity of such innovation, society has become more prone to demand novel ideas and innovative thinkers. This bias toward innovation has raised the bar not only for industries, computers, and manufacturing, but also for a beneficiary wishing to express gratitude to a benefactor. Many people who receive such an expression want that expression to be as unique as the ideas that sparked the computer and Industrial Revolutions. Furthermore, it is sometimes valuable for an individual to have something that money, fame, or power cannot buy. It could be desirable for a benefactor to have something that nobody else can ever have no matter how rich, powerful or famous others might be. In light of this, a significant drawback to the aforementioned methods is that they lack novelty and innovative thought. Furthermore, others can practice these methods as they please. There is no way to exclude others from using these methods in order to tout that the benefactor is the first, only, and last to have gratitude expressed in such a fashion. Also, these methods cannot be recorded perpetually for the entire world to see.

Accordingly, a need exists for a unique, novel, and recorded method of expressing gratitude for a benefit where others are excluded from expressing gratitude in the same manner.

### SUMMARY OF THE INVENTION

In this invention, an improved method for expressing gratitude for a scholastic experience is disclosed. The method of the present invention generally comprises the steps of providing a beneficiary and at least one benefactor; drafting a government document having an expression of gratitude incorporated therein; showing the government document to the at least one benefactor; and interpreting the government document.

The method may further comprise a second benefactor. The first and second benefactor may be the mother and father of the beneficiary. The method of the present invention may also comprise the government document being a patent application. The patent application may then disclose a method by which the beneficiary will express gratitude. The beneficiary could then implement the claimed method to express gratitude to the benefactors. The patent application could be the expression of gratitude.

After drafting the government document, the government document is shown to the benefactors. The beneficiary may have a fiancé give the government document to the benefactors during a graduation ceremony. The benefactors could then interpret the expression of gratitude incorporated in the government document. In the situation where the benefactors accept the expression of gratitude, the beneficiary signs and deposits the government document with the United States Postal Service.

One of the principal objects of the invention is to provide a method by which a beneficiary's level of gratitude is realized by a benefactor.

Yet another object of the invention is to provide an entirely unique method for a beneficiary to express gratitude to a benefactor.

Still another object of the invention is to provide a method of expressing gratitude where the benefactor can righteously tout the uniqueness of the expression.

Yet another object of the invention is to provide a method of expressing gratitude where the benefactor is the first, only, and last person to ever have gratitude expressed by such a method.

Still another object of the invention is to provide a method of expressing gratitude where the method is at least partially related to the beneficiary's future profession.

Still another object of the invention is to provide a method of expressing gratitude to a benefactor where the method is recorded in a government document for the entire world to see.

These and other objects will be obvious to those skilled in the art.

### BRIEF DESCRIPTION OF THE DRAWINGS

FIG. 1 is a flow diagram of the present invention.

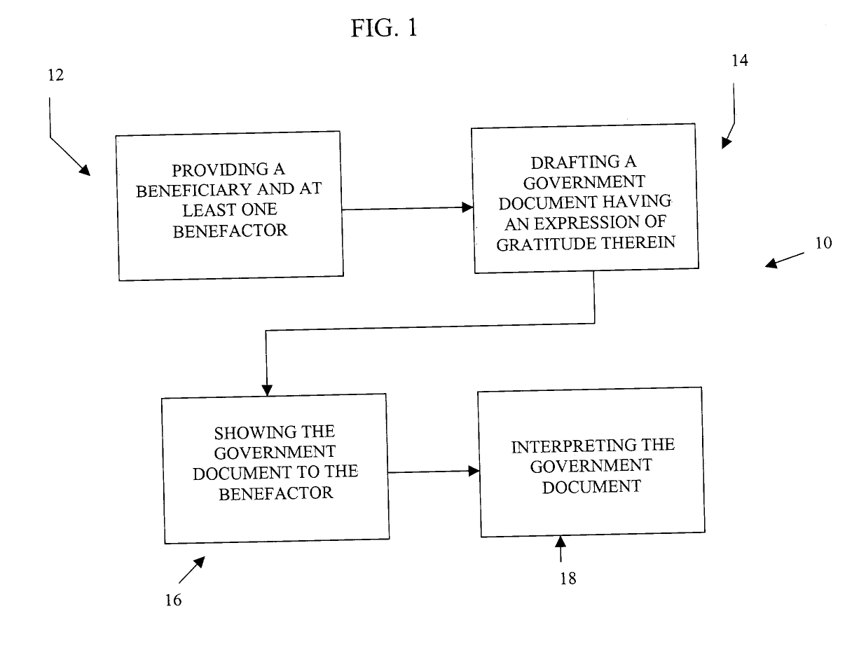

### DESCRIPTION OF THE PREFERRED EMBODIMENT

In the drawings, the method of expressing gratitude for a scholastic experience is generally referred to by the reference numeral 10. Method 10 generally comprises the steps of providing a beneficiary and at least one benefactor; drafting a government document where an expression of gratitude for a scholastic experience is incorporated therein; showing the government document to a benefactor; and interpreting the expression of gratitude in the government document. Preferably, the government document is a patent application. The patent application may claim the method by which the beneficiary will express gratitude to the at least one benefactor. The beneficiary could then use the method claimed in the patent application to express gratitude to the at least one benefactor. The patent application could be the expression of gratitude.

Reference numeral 12 generally refers to the step of providing a beneficiary and at least one benefactor. In many situations, step 12 will include a second benefactor. In such a situation, the first benefactor is preferably named Ted Grace (hereinafter “Ted”), the second benefactor is preferably named Irene Grace (hereinafter “Irene”), and the beneficiary is preferably named Ryan Grace (hereinafter “Ryan”). Ted and Irene might also be the father and mother of Ryan. Preferably, Ted and Irene are supportive parents who have been a significant influence on Ryan.

At some point during the relationship between Ted, Irene and Ryan, it might be desirable for Ryan to express gratitude to Ted and Irene for a benefit. Such situations might include Ted and Irene supporting Ryan throughout high school, college, the patent bar, and law school. In the situation where Ryan decides to express gratitude to Ted and Irene, Ryan drafts the expression of gratitude in a government document as generally defined by drafting step 14. Preferably, the government document is a patent application. Where the government document is a patent application, the patent application may have the expression of gratitude disclosed and claimed therein. The patent application may also disclose and claim the method by which an expression of gratitude may occur. Such a method disclosed and claimed in the patent application might also be the very method by which the expression of gratitude did occur. The patent application could be the actual expression of gratitude.

After drafting the government document, the government document is shown to Ted and Irene as generally defined by the showing step 16. As stated above, the government document is preferably a patent application. In one of the preferred embodiments, the showing step 16 might further include Ryan finishing a third year of law school and participating in the law school graduation ceremony. In one of the most desirable embodiments, Ryan might also have a fiancé named Ellen Colyer (hereinafter “Ellen”). During the graduation ceremony Ryan might be seated on the floor of a convention hall with his law school class. Ellen might be seated with Irene and Ted. Although not necessary, Ellen might have the patent application in her possession.

In the best mode of this invention Ryan receives a diploma during the graduation ceremony. At the very moment when Ryan receives his diploma, Ellen preferably gives the patent application to Ted and Irene. Ted and Irene will then interpret the document as generally defined by the interpreting step 18. Preferably, Ted and Irene interpret at least one claim of the patent application as specifically reciting:
“I have no idea where to begin in thanking you two for all you have done for me over the last twenty-six years. Your support throughout high school, college, and law school has allowed me to pursue many of my interests that would have been set aside if it was not for your help. This time and education you two have given me is irreplaceable. The example you two have set has driven me in more ways then I care to express in a patent application, and the manner in which you two have approached life has given me a confident outlook on my own future. I hope someday, in some way, I can repay you two for all you have done. However corny this may be, I know of no other way to express the sincerity of my gratitude. Thank you.”

Ryan may hope that Ted and Irene accept the expression of gratitude as an honest, sincere expression for all they have done over the last twenty-six years. In the ideal situation where Ted an Irene find the gratitude sufficient, Ryan should sign the patent application and deposit the patent application with the United States Postal Service. Preferably, the United States Patent and Trademark Office receives the patent application and, upon examination, issues a patent on the same.

In the drawing and in the specification, there have been set forth preferred embodiments of the invention and although specific items and methods are employed, these are used in a generic and descriptive sense only and not for purposes of limitation. Changes in the form, timing, and manner of events, as well as a substitution of equivalents, are contemplated as circumstances may suggest or render expedient without departing from the spirit or scope of the invention as further defined in the following claims. Furthermore, nothing in the aforementioned description of the preferred embodiment is to be interpreted as an admission by the applicant of prior art.

Thus, it can be seen that the invention accomplishes at least all of its stated objectives.

1. A method for expressing gratitude for a scholastic experience by converting a patent application into an expression of gratitude document, comprising;
drafting a patent application to disclose an invention, wherein the patent application is drafted in a tangible medium;
drafting an expression of gratitude for a scholastic experience, wherein the expression of gratitude is drafted in a tangible medium;
incorporating the expression of gratitude for a scholastic experience into the patent application, wherein the patent application is converted into an expression of gratitude document for expressing gratitude during an expression of gratitude event.

2-10. (canceled)

11. The method of claim 1 wherein at least one of said claims of the expression of gratitude document recites:
“I have no idea where to being in thanking you two for all you have done for me over the last twenty six years. Your support throughout high school, college and law school has allowed me to pursue many of my interests that would have been set aside if it was not for your help. This time and education you two have given me are irreplaceable. The example you two have set has driven me in more ways then I care to express in a patent application, and the manner in which you two have approached life has given me a whole new outlook on my own fixture. I hope someday, in some way, I can repay you two for all you have done. However corny this may be, I know of no other way to express the sincerity of my gratitude. Thank you.”

12. The method of claim 1 further comprising signing the expression of gratitude document and depositing the expression of gratitude document with the United States Postal Service.

13. The method of claim 1 further comprising sending the expression of gratitude document to the United States Patent and Trademark Office.

14-15. (canceled)

16. A method for expressing gratitude for a scholastic experience by utilizing a patent application as an expression of gratitude document, comprising;
drafting a patent application, wherein the patent application is drafted in a tangible medium;
drafting an expression of gratitude for a scholastic experience, wherein the expression of gratitude is drafted in a tangible medium;
incorporating the expression of gratitude for a scholastic experience into the patent application, wherein the patent application is converted into an expression of gratitude document;
presenting the expression of gratitude document to a benefactor during an expression of gratitude event;
signing the expression of gratitude document; and
sending the expression of gratitude document to the United States Patent and Trademark Office.

17. The method of claim 17 wherein at least one of the claims of the expression of gratitude document recites:
“I have no idea where to being in thanking you two for all you have done for me over the last twenty six years. Your support throughout high school, college and law school has allowed me to pursue many of my interests that would have been set aside if it was not for your help. This time and education you two have given me are irreplaceable. The example you two have set has driven me in more ways then I care to express in a patent application, and the manner in which you two have approached life has given me a whole new outlook on my own future. I hope someday, in some way, I can repay you two for all you have done. However corny this may be, I know of no other way to express the sincerity of my gratitude. Thank you.”

18. A method for expressing gratitude for a scholastic experience by utilizing a patent application as an expression of gratitude document, comprising;
drafting a patent application, wherein the patent application is drafted in a tangible medium;
drafting an expression of gratitude for a scholastic experience, wherein the expression of gratitude is drafted in a tangible medium;
incorporating the expression of gratitude for a scholastic experience into the patent application;
presenting the patent application to a benefactor during an expression of gratitude event;
signing the patent application; and
sending the patent application to the United States Patent and Trademark Office.

19. The method of claim 18 wherein at least one of the claims of the expression of gratitude document recites:
“I have no idea where to being in thanking you two for all you have done for me over the last twenty six years. Your support throughout high school, college and law school has allowed me to pursue many of my interests that would have been set aside if it was not for your help. This time and education you two have given me are irreplaceable. The example you two have set has driven me in more ways then I care to express in a patent application, and the manner in which you two have approached life has given me a whole new outlook on my own future. I hope someday, in some way, I can repay you two for all you have done. However corny this may be, I know of no other way to express the sincerity of my gratitude. Thank you.”
